(19) United States
(12) Patent Application Publication
(10) Pub. No.: US 2007/0160707 A1
(43) Pub. Date: Jul. 12, 2007

(54) MULTIPLE PHASE CONFECTIONERY PRODUCT WITH GEL COMPONENT AND METHOD

(76) Inventor: Albert Xambo Garcia, Sabadell (ES)

Correspondence Address: BELL, BOYD & LLOYD LLP, P.O. Box 1135, CHICAGO, IL, 60690, US

(21) Appl. No.: 11/610,207

(22) Filed: Dec. 13, 2006

Related U.S. Application Data
(60) Provisional application No. 60/755,282, filed on Dec. 30, 2005.

(51) Int. Cl. A23G 4/00

(52) U.S. Cl. 426/3

(57) ABSTRACT

The present disclosure is directed to a multiple phase confectionery article having a confectionery substrate and a stabilized gel component in contact with the confectionery substrate. The stabilized gel component includes a stabilizing agent that improves the gel matrix by increasing the water and flavor retention of the gel, raising the gel set point temperature, and increasing gel density. The stabilized gel component may be suitable for single phase or multiple phase gel-crème confectionery products.

### PRIORITY CLAIM

This application claims the benefit of U.S. Provisional Patent Application Serial No. 60/755,282 filed on Dec. 30, 2005, the entire content of which is incorporated by reference herein.

### BACKGROUND

Confectioneries having a gel component are known. Such candies are typically glycerin-based or prepared using an acid-catalyzed gelling agent. Glycerin-based confectionery gels, however, fail to provide favorable organoleptic properties when used with certain flavor profiles. Glycerin-based gels fail to provide a suitable mouthfeel for many crème-based profiles, for example. Similarly, the sour and acidic nature of acid-catalyzed gelling agents is incompatible with many flavors. For example, acid-catalyzed gelling agents degrade chocolate-based flavorants. A need therefore exists for a confectionery gel that is compatible with a wider array of flavors than glycerin-based and acid catalyzed gels. A need further exists for a multiple phase confectionery article having a gel component that may be used to form a crème-type gel component with a rich cream flavor, mouthfeel, and texture.

### SUMMARY

The present disclosure is directed to a multiple phase confectionery article having a confectionery substrate in contact with a stabilized gel component. The stabilization of the gel component improves the properties and character of the gel matrix. The stabilized gel component produces a rich, attractive gel or gel-crème that is compatible with a wide array of flavors. In addition, the composition of the stabilized gel component further enhances the process-ability of the confectionery article.

In an embodiment, the confectionery substrate may be chewing gum, bubble gum, trim chewing gum, nougat, pliable confectionery material, taffy, soft candy, chewy candy, caramel, hard candy, or any combinations thereof.

In an embodiment the stabilized gel component may include a hydrocolloid, a stabilizing agent, a flavorant, and a sweetener. In a further embodiment, the stabilized gel component may include a dairy component.

In an embodiment, the hydrocolloid may be gelatin, gellan gum, xanthan gum, pectin, carrageenan, and combinations thereof. In a further embodiment, the stabilizing agent may be agar, alginate, locust bean gum, carrageenan, iota carrageenan, kappa carrageenan, and any combination thereof.

In an embodiment, the confectionery substrate may be from about 50% to about 90% by weight of the confectionery article. In a further embodiment, the stabilized gel component may be from about 10% to about 50% by weight of the confectionery article.

In yet a further embodiment, a multiple phase chewing gum composition is provided. The multiple phase chewing gum may include a chewing gum substrate and a stabilized gel component in contact with the chewing gum substrate. The chewing gum substrate may be chewing gum, bubble gum, trim chewing gum, and combinations thereof.

In an embodiment, the stabilized gel component may include a hydrocolloid, a stabilizing agent, a flavorant, a sweetener, a dairy component, and combinations thereof. In yet a further embodiment, the hydrocolloid may include xanthan gum, pectin, carrageenan, and combinations thereof. In a further embodiment, the stabilizing agent may include alginate, locust bean gum, carrageenan, iota carrageenan, kappa carrageenan, and combinations thereof.

In an embodiment, the stabilized gel component may have one or more of the following properties: a cream texture, a creamy mouthfeel, a cream flavor, and any combination of the same.

In an embodiment, the stabilized gel component may have a set point temperature from about 90° C. to about 92° C. In a further embodiment, the stabilized gel component may have a Brix value from about 85 to about 87.

In an embodiment, the shape of the chewing gum composition may be varied as desired. The chewing gum composition may be a laminate, an extruded or a coextruded product, or a sandwich-type structure product. In an embodiment, the chewing gum composition may have a channel extending along a length thereof, with an amount of the stabilized gel component disposed in the channel. In a further embodiment, the chewing gum substrate of the chewing gum composition may have a cross-section shape being square-shaped, E-shaped, O-shaped, U-shaped, or W-shaped. These configurations advantageously reduce the chance of contact and/or adhesion between processing equipment and/or product packaging with the stabilized gel component.

In yet a further embodiment, the chewing gum substrate may encase, either wholly or partially, the stabilized gel component. In an embodiment, the stabilizing gel component may be visible at an end of the chewing gum composition. In yet another embodiment, the chewing gum composition may include a layer of trim chewing gum.

The present multiple component confectionery article may advantageously provide two confectionery phases with distinctly different textures, mouthfeel, and/or flavor. The present confectionery article further advantageously provides a stabilized gel component that is self-standing, and does not seep, leak, or ooze from the confectionery product. The stabilized gel component is advantageously adapted for crème-based flavor profiles. The stabilized gel component advantageously does not stick to the wrapping in which it is packaged.

In an embodiment, a method for producing a multiple phase confectionery article is provided. The method may include extruding a confectionery substrate and dispensing a stabilized gel component upon the confectionery substrate to form a confectionery composite. The stabilized gel component may have a gel set point temperature, and the temperature of the stabilized gel component may be above the set point temperature. The method may further include lowering the temperature of the confectionery composite below the gel set point temperature to gel the stabilized gel component to form the confectionery article. In an embodiment, the method may include maintaining the stabilized gel component in a fluid state during the dispensing. In a further embodiment, the method may include maintaining the temperature of the stabilized gel component above the set point temperature during the dispensing.

In an embodiment, the method may include passing the confectionery article through a cooling chamber having a temperature from about −2° C. to about 2° C. for about 1 minute to about 7 minutes.

In an embodiment, the method may include coextruding the stabilized gel component with the confectionery substrate.

In an embodiment, the method may include forming a channel in the confectionery substrate and dispensing the fluid stabilized gel component in the channel.

In an embodiment, the method may include placing the confectionery article in a package, the stabilized gel component not adhering to the package. In a further embodiment, the method may include packaging the confectionery article within about 1 minute to about 10 minutes after the temperature has been lowered below the gel set point temperature.

Additional features and advantages are described herein, and will be apparent from, the following Detailed Description and the figures.

### BRIEF DESCRIPTION OF THE FIGURES

FIG. 1 is a schematic representation of a system for preparing a confectionery article in accordance with the present disclosure.

FIG. 2 is an elevation view of a portable stabilized gel component injection device in accordance with an embodiment of the present disclosure.

FIG. 3 is a sectional view of a confectionery rope in accordance with an embodiment of the present disclosure.

FIG. 4 is a sectional view of a confectionery rope in accordance with an embodiment of the present disclosure.

FIG. 5 is a perspective view of a confectionery product in accordance with an embodiment of the present disclosure.

FIG. 6 is a perspective view of a confectionery product in accordance with an embodiment of the present disclosure.

FIG. 7 is a perspective view of a confectionery product in accordance with an embodiment of the present disclosure.

FIG. 7A is a perspective view of the confectionery product of FIG. 7 showing the interior thereof.

FIG. 8 is a perspective view of a confectionery product in accordance with an embodiment of the present disclosure.

FIG. 8A is a perspective view of the confectionery product of FIG. 8 showing the interior thereof.

FIG. 9 is a schematic representation of a system for preparing a confectionery article in accordance with an embodiment of the present disclosure.

FIG. 10 is a sectional view of a multiple phase confectionery product in a packaging in accordance with an embodiment of the present invention.

FIG. 11 is a sectional view of a multiple phase confectionery product in a packaging in accordance with an embodiment of the present invention.

FIG. 12 is a sectional view of a multiple phase confectionery product in a packaging in accordance with an embodiment of the present invention.

### DETAILED DESCRIPTION

The present disclosure is directed to a multiple phase confectionery article having a confectionery substrate and a stabilized gel component in contact with the confectionery substrate. The confectionery substrate may be any hard candy, soft candy, chewing gum, or other confectionery substance, material, or compound that has a fluid phase or may take a flowable form. In other words, the confectionery substrate may be melted, form a syrup, or be dissolved at a temperature above ambient to become flowable as is commonly known in the art. The skilled artisan will appreciate that the moisture content (and concomitant viscosity) of the confectionery substrate may vary greatly. The moisture content of the flowable phase of the confectionery substrate may typically be in the range of about 2% to about 20% by weight of the confectionery substrate. The flowable confectionery material may be subsequently cooled or solidified at room temperature to form a solid confectionery substrate. Nonlimiting examples of suitable confectionery products that are flowable or may placed into a flowable state include syrups, liquids or solids for making hard candies, soft candies, lollipops, fondants, toffees, jellies, chewing gums, chocolates, gelatins and nougats. The confectionery substrate may include sugar or may be sugar-free. Coloring may be added to the confectionery substrate as desired. The confectionery substrate may also include a pharmaceutical product or a medicament.

In an embodiment, the confectionery substrate may by a soft candy. Nonlimiting examples of suitable soft candies may include chewing gum, bubble gum, nougat, pliable confectionery material, taffy, gummy candy, chewy candy, caramel, and combinations thereof.

The present multiple phase confectionery article also includes a stabilized gel component in contact with the confectionery substrate. Nonlimiting examples by which contact may occur between the substrate and the stabilized gel component include adherence, extrusion, coextrusion, dispensed, co-dispensed, lamination, as is commonly known in the art.

The stabilized gel component includes an additive, stabilizer, or stabilizing agent that improves the character and properties of gel matrix. Incorporation of the stabilizing agent into the gel matrix improves the gel by increasing moisture and flavor retention over time, and may also serve to thicken or otherwise increase the gel density. The stabilizing agent and the gelling agent may be the same or different. Further advantages and properties of the gel component that is stabilized will be discussed in detail below.

In an embodiment, the stabilized gel component may include a matrix of a gel or a gelling agent and a stabilizing agent. In an embodiment, other components such as a sweetener, a flavor, a dairy component, or any combination thereof may be incorporated into the stabilized gel component. In an embodiment, the gel component may be a hydrocolloid compound. Hydrocolloids are typically hydrophilic and readily absorb water to increase in viscosity and impart smoothness and body texture to a product. Nonlimiting examples of suitable hydrocolloids include gelatin, gellan gum, xanthan gum, pectin, carrageenan, and combinations thereof.

In an embodiment, the stabilizing agent may be agar, alginate, locust bean gum, carrageenan, iota carrageenan, kappa carrageenan, and combinations thereof. In an embodiment, the stabilized gel component may further include a flavor agent or flavorant, a sweetener, and combinations thereof. The sweetener may contain sugar or may be sugar-free.

Nonlimiting examples of suitable flavorants include natural and synthetic flavoring agents chosen from synthetic flavor oils and flavoring aromatics, and/or oils, oleo resins and extracts derived from plants, leaves, flowers, fruits and so forth, and combinations thereof. Nonlimiting examples of flavor oils include spearmint oil, cinnamon oil, oil of wintergreen (methylsalicylate), peppermint oils, clove oil, bay oil, anise oil, eucalyptus oil, thyme oil, cedar leaf oil, oil of nutmeg, oil of sage, oil of bitter almonds, and cassia oil. Also nonlimiting examples of artificial, natural or synthetic fruit flavors include vanilla, cream, caramel, banana, cocoa, and citrus oil, including lemon, orange, grape, lime and grapefruit and fruit essences including apple, pear, peach, strawberry, raspberry, cherry, plum, pineapple, apricot and so forth. It is understood that these flavorants may be used alone or in combination with or without a cooling agent, or a physiological cooling agent, as is commonly known in the art.

Nonlimiting examples of suitable sugar sweeteners include saccharide-containing components such as sucrose, dextrose, maltose, dextrin, dried invert sugar, fructose, levulose, galactose, corn syrup, corn syrup solids, and the like, alone or in combination, as are commonly known in the art. Nonlimiting examples of sugarless sweeteners include sugar alcohols such as sorbitol, erythritol, mannitol, isomalt, xylitol, hydrogenated starch hydrolysates, maltitol, and the like, alone or in combination. In a further embodiment, the sweetener may include, in whole or in part, a high intensity sweetener including such non-limiting examples as sucralose, aspartame, salts of acesulfame, alitame, saccharin and its salts, neotame, cyclamic acid and its salts, glycyrrhizin, dihydrochalcones, thaumatin, monellin, and the like, alone or in combination.

In a further embodiment, the confectionery substrate may be from about 50% to about 90% by weight of the confectionery article. In yet a further embodiment, the stabilized gel component may be from about 10% to about 50% by weight of the confectionery article. In a further embodiment, the confectionery substrate may encase the stabilized gel component. In still a further embodiment, the confectionery article may have a channel extending along a length thereof, and the fill component may be disposed in the channel.

Not wishing to be bound by any particular theory, it is believed that the stabilizing agent improves the gel matrix. Many confectionery gels, and hydrocolloids in particular, tend to contract, constrict, shrink, or tighten over time. This yields physical, visual, and/or organoleptic defects such as cracking, brittleness, hardened texture, and flavor loss. These deficient traits result in reduced product shelf life and diminished consumer appeal.

Incorporation of the stabilizing agent into the gel matrix provides several improvements and advantages. The stabilizing agent retains moisture in the matrix. This prevents cracking, brittleness and maintains the gel in a soft and chewy state. The moisture retention capability of the stabilizing agent further improves or otherwise extends the product shelf life. Moreover, the stabilizing agent may serve as a thickener to increase gel density. This advantageously provides a rich, robust, creamy mouthfeel and texture that is particularly well-suited for crème-type gels and/or cream-style candies.

Moreover, provision of the stabilizing agent in the gel matrix also improves the process-ability of the confectionery gel component. The stabilizing agent increases or otherwise raises the gel set point temperature for the gel component. It is understood that the gel set point temperature or the gel set point is the temperature at which the fluid form of the gel forms the gel matrix. The stabilized gel component with a raised gel set point provides a gel component that “gel-ifies”, solidifies, or otherwise gels rapidly. Rapid gelation during processing is advantageous as it permits handling of the confectionery product immediately after product formation. Rapid gelation further reduces the adhesive properties of the gel component during production. This reduces the amount of sticking and adhesion of the gel component and the confectionery product on processing equipment and personnel. This advantageously increases production rates and reduces wait time for packaging. In an embodiment, the stabilized gel component may have a gel set point temperature of from about 88° C. to about 93° C. In a further embodiment, the stabilized gel component may have a Brix value from about 82 to about 87.

Moreover, rapid gelation vis-à-vis a high set point eliminates the need for an acid-catalyzed gelling agent. Avoidance of acid catalyzed gelling agents is advantageous as more flavors may be incorporated into confectionery gels. The acidic and sour nature of acid-catalyzed gelling agents is incompatible with many flavors and/or sweeteners. Avoidance of an acid-catalyzed gelling agent, permits a wide array of flavorants not previously viable with acid-catalyzed gelling agents to be incorporated in the present stabilized gel matrix. In particular, the sour nature of acid-catalyzed gelling agents is not compatible with cream-style gel candies. Indeed, acid-catalyzed gel agents are known to degrade chocolate or cocoa-based flavors. In an embodiment, the stabilized gel component may be utilized to produce a cream gel candy or a crème gel confectionery filling. In an embodiment, the stabilized gel component may have a cream texture or a rich, creamy mouthfeel and/or creamy appearance. In an embodiment, the stabilized gel component may be produced or formed into a stand-alone, single phase crème confectionary product or crème candy.

Thus, the stabilizing agent of the stabilized gel component advantageously provides a stabilized gel matrix that 1) improves product shelf life by preventing cracking, drying, or constriction of the gel-flavor-sweetener matrix, 2) improves gel flavor retention, 3) improves process-ability by providing a high gel set point for rapid gelling of the gel component, and 4) provides a thickened gel with a rich creamy mouthfeel well-suited for crème gels that does not require an acid catalyzed gelling agent.

In an embodiment, a chewing gum substrate and the stabilized gel component may be combined to prepare a multiple phase chewing gum composition. A variety of chewing gum formulations may be used to create the chewing gum substrate. In an embodiment, the chewing gum substrate may be chewing gum, bubble gum, or trim chewing gum. Chewing gum generally consists of a water insoluble gum base, a water soluble portion, and flavors.

The insoluble gum base generally comprises elastomers, resins, fats and oils, softeners, and inorganic fillers. The gum base may or may not include wax. The insoluble gum base can constitute approximately 5 to about 95 percent, by weight, of the chewing gum, more commonly, the gum base comprises 10 to about 50 percent of the gum, and in some preferred embodiments, 20 to about 35 percent, by weight, of the chewing gum.

In an embodiment, the chewing gum of the present invention contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants, etc.

Synthetic elastomers may include, but are not limited to, polyisobutylene with a GPC weight average molecular weight of about 10,000 to about 95,000, isobutylene-isoprene copolymer having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight, for styrene-butadiene, for polyvinyl acetate, 10,000 to 65,000 GPC weight average molecular weight with the higher molecular weight polyvinyl acetates typically used in bubble gum base, and for vinyl acetate-vinyl laurate, vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters, often called estergums, such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing the preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

In addition to a water insoluble gum base portion, a typical chewing gum composition includes additional ingredients such as a bulking agent or water soluble bulk portion and one or more flavoring agents. For example, the ingredients can include bulk sweeteners, high intensity sweeteners, flavoring agents, softeners, emulsifiers, colors, acidulants, fillers, antioxidants, preservatives and other components or processing aids or combinations thereof that provide desired attributes.

Softeners can be added to the chewing gum in order to optimize the chewability and mouth feel of the gum. The softeners, which are also known as plasticizers and plasticizing agents, generally constitute between approximately 0.5 to about 15% by weight of the chewing gum. The softeners may, in addition to including caprenin, include glycerin, lecithin, and combinations thereof. Aqueous sweetener solutions such as those containing sorbitol, hydrogenated starch hydrolysates, corn syrup, other polyols or sugars, such as tagatose, and combinations thereof, may also be used as softeners and binding agents in chewing gum.

Bulk sweeteners include both sugar and sugarless components. Bulk sweeteners typically constitute 5 to about 95% by weight of the chewing gum, more typically, 20 to 80% by weight, and more commonly, 30 to 60% by weight of the gum.

Sugar sweeteners generally include saccharide-containing components commonly known in the chewing gum art, including, but not limited to, sucrose, dextrose, maltose, dextrin, dried invert sugar, fructose, tagatose, galactose, corn syrup solids, and the like, alone or in combination.

Maltitol can be used as a sugarless sweetener. Additionally, sugarless sweeteners can include, but are not limited to, other sugar alcohols such as mannitol, xylitol, hydrogenated starch hydrolysates, sorbitol, lactitol, and the like, alone or in combination.

High intensity artificial or natural sweeteners can also be used in combination with the above. Preferred sweeteners include, but are not limited to sucralose, aspartame, salts of acesulfame, alitame, neotame, saccharin and its salts, cyclamic acid and its salts, glycyrrhizin, stevioside, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8%. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Example of low caloric bulking agents include: polydextrose; Raftilose; Raftilin; Fructooligosaccharides (NutraFlora); Palatinose oligosaccharide; Guar Gum Hydrolysate (Sun Fiber); or indigestible dextrin (Fibersol). However, other low calorie bulking agents can be used.

A variety of flavoring agents can be used. The flavor can be used in amounts of approximately 0.1 to about 15 weight percent of the gum, and preferably, about 0.2 to about 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorally acceptable fashion.

FIGS. 1-4 illustrate a production system for the preparation of the multiple phase chewing gum composition. Although system 10 is directed to a chewing gum composition, it is understood that the system may be used to produce the multiple phase confectionery article as previously described herein. System 10 includes an extruder 12 for extruding chewing gum and an extrusion nozzle 14. In an embodiment extruder 12 may include extruder 16 for extruding chewing gum substrate 18. In a further embodiment, extruder 12 may include fresh gum extruder 16 and trim gum extruder 20 for extruding trim gum 22. Trim gum 22 may be any reprocessed gum from a previous batch, scrap gum, recycled gum, or chewing gum that has been in contact with or includes some stabilized gel component. It is understood that extruder 12 may or may not include trim gum extruder 20. Each extruder 16 and 20 may include a respective pre-extruder 16a, 20a as is commonly known in the art.

Extruder 12 delivers extruded chewing gum substrate 18 and optionally extruded trim gum 22 to nozzle 14. The temperature of the chewing gum exiting nozzle 14 may be from about 45° C. to about 55° C., or about 50° C. Nozzle 14 may be adapted to provide various shapes or configurations for the chewing gum composition as will be described.

In an embodiment, a source 24 of stabilized gel component 26 may be placed in fluid communication with nozzle 14 by way of tubing or piping 28. In an embodiment, source 24 may be heated and/or insulated to maintain the temperature of stabilized gel component 26 above the gel set point temperature. Thus, stabilized gel component 26 may be maintained in a fluid or flowable state while the stabilized gel component is dispensed. The set point temperature of stabilized gel component 26 may be from about 88° C. to about 92° C., or about 90° C. In a further embodiment, stabilized gel component 26 may have a Brix value of about 84-87, or about 85 to about 86. In an embodiment, piping 28 may also be heated and/or insulated to deliver stabilized gel component 26 at a temperature above the set point temperature to nozzle 14.

In an embodiment, the stabilized gel component may be prepared by adding a hydrocolloid, a stabilizing agent, and sugar to a water solution that is at a temperature above the gel set point. In an embodiment, the water may be heated to a temperature above about 90° C. Flavor and sugar may be blended together and may also be added to the water solution. Titanium dioxide, glucose, and additional flavor may be added as desired. The mixture may be stirred under pressure (about 250-300 mm Hg). In an embodiment, preparation of the stabilized gel solution may be considered complete when the mixture obtains a Brix value of about 85-86.

In a further embodiment, a stabilized gel component may be prepared by following the process set forth in Table 1 below.

TABLE 1
The stabilized gel component may be made as follows:

| | |
|---|---|
| 1. | Heat water to 80° C. in a cooker |
| 2. | Add hydrocolloid powder blend |
| 3. | Mix until all dissolved |
| 4. | Add the Glucose Syrup |
| 5. | Add the dry powder mix |
| 6. | Cook under vacuum (approx 220 mm Hg) until 86-87 Brix |
| | (above 85 Brix) |
| 7. | Add chocolate flavor & titanium dioxide |
| 8. | The stabilized gel component may then be transferred into |
| | a “portable injection system” and taken to the production |
| | line, where, through a nozzle arrangement in the extruder, |
| | the gum and stabilized gel component are put together to |
| | form the gum around the stabilized gel component arrange- |
| | ment in a rope |
| 9. | Rope goes through a cooling chamber |
| 10. | The rope is then cut and wrapped |

In an embodiment, the hydrocolloid may be xanthan gum, pectin, carrageenan, and combinations thereof. In a further embodiment, the stabilizing agent may be alginate, locust bean gum, carrageenan, iota carrageenan, kappa carrageenan, and combinations thereof. The ratio of hydrocolloid-to-stabilizing agent may be varied as desired. Nonlimiting examples suitable hydrocolloid-stabilizer gel matrices are set forth in Table 2 below.

TABLE 2

| | | CONCENT. | |
|---|---|---|---|
| | | STAB. | |
| | | HYDROCOLL. | |
| STABILIZED | | TOTAL FINAL | DRY |
| HYDROCOLLOID | RATIO | PROD. | SOLID |
| Locust Bean/Xanthan | 80:20 | 0.29% | 85.00% |
| Locust Bean/Xanthan | 60:40 | 0.41% | 85.00% |
| Pectin - Alginate | 100% | 0.60% | 85.00% |
| Pectin - Alginate | 100% | 0.74% | 87.00% |
| Locust Bean/Xanthan | 60:40 | 0.75% | 85.00% |
| Locust Bean/Xanthan | 60:40 | 0.75% | 85.00% |
| Locust Bean/Xanthan | 60:40 | 0.77% | 87.00% |
| Locust Bean/Xanthan | 60:40 | 0.77% | 87.00% |
| Pectin - Alginate | 100% | 1% | 87.00% |
| Pectin - Alginate | 100% | 1% | 87.00% |
| Pectin - Alginate | 100% | 1% | 87.00% |
| Locust Bean/Xanthan | 60:40 | 0.77% | 87.00% |
| Locust Bean/Carrageenan | 31:69 | 0.37% | 85.00% |
| Locust Bean/Carrageenan | 31:69 | 0.37% | 87.00% |
| Locust Bean/Carrageenan | 16:84 | 0.48% | 82.00% |
| Locust Bean/Carrageenan | 16:84 | 0.48% | 85.00% |
| Locust Bean/Carrageenan | 16:84 | 0.48% | 87.00% |

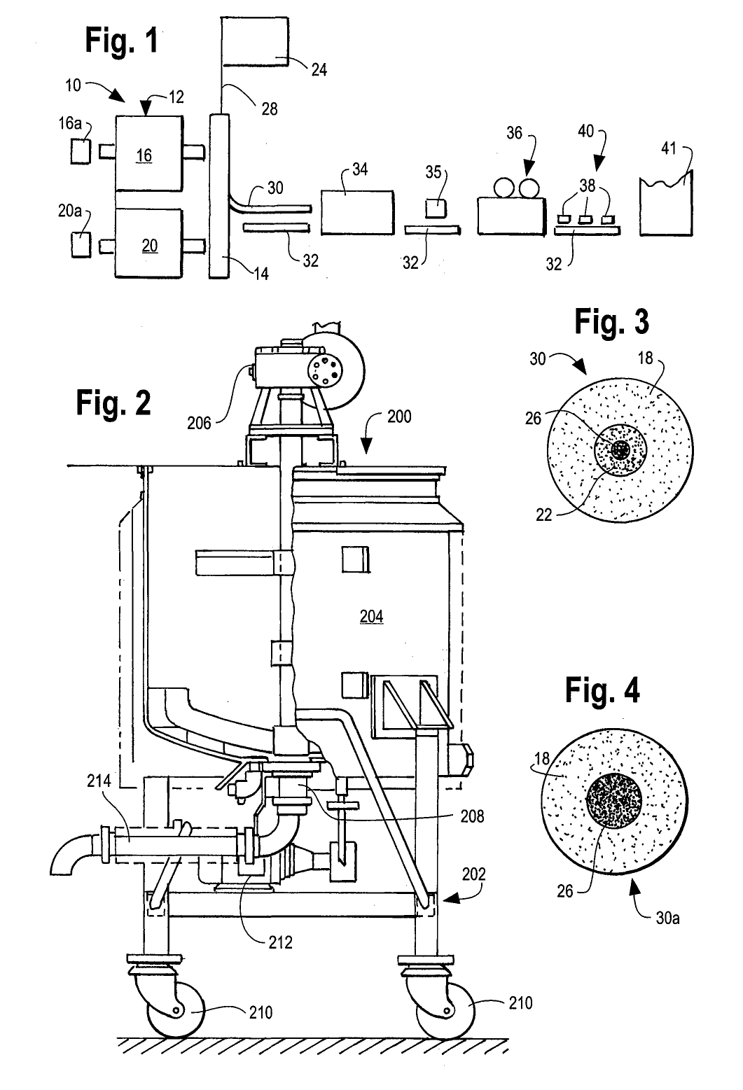

In an embodiment, source 24 may be a portable gel injection system 200 as shown in FIG. 2. Portable gel injection system 200 may include a base 202 upon which a tank 204 having an inlet 206 and an outlet 208 resides. System 200 may also include wheels 210 attached to base 202. Tank 204 may be heated, insulated and/or pressurized in order to maintain the stabilized gel component above the gel set point (i.e., in a fluid state). Inlet 206 may be used to receive stabilized gel component that is prepared in a cooking unit. System 200 may then be rolled to the confectionery product assembly line to thereby transfer the stabilized gel component from cooking unit, to the production line. In an embodiment, portable system 200 may further include pump 212 for delivering fluid stabilized gel component to system 10 in a uniform manner. Tubing 214 may be heated and/or insulated to maintain the fluid stabilized gel component above the set point temperature during transfer to system 10.

Returning to FIG. 1, in an embodiment, nozzle 14 may be a coextrusion nozzle to coextrude chewing gum substrate 18, trim gum 22, and stabilized gel component 26 as a continuous confectionery rope 30 onto a transport mechanism, such as conveyor 32. Rope 30 may include chewing gum substrate 18 as an outer layer, trim gum 22 as an intermediate or middle layer, and stabilized gel component 26 as an inner layer as shown in FIG. 3. Alternatively, nozzle 14 may be used to form a trim-less confectionery rope 30a having chewing gum substrate 18 as an outer layer and stabilized gel component 26 as an inner layer as shown in FIG. 4. It is understood that the system used to produce rope 30a does not utilize trim gum extruder 20.

Conveyor 32 delivers confectionery rope 30 to cooling chamber 34. In an embodiment, cooling chamber 34 exposes confectionery rope 30 to a temperature less than about 2° C., or from about −2° C. to about 2° C. Although not wishing to be bound by any particular theory, it is believed that stabilized gel component 26 may begin to initially gel upon contact with the cooler extruded chewing gum substrate 18 (and optionally trim gum 22). Upon entry into cooling chamber 34, stabilized gel component rapidly gels to a non-flowing, self-standing gel. In an embodiment, confectionery rope 30 remains in cooling chamber 34 for about 1 minute to about 10 minutes, or about 1 minute to about 7 minutes, or about 3 minutes to about 6 minutes. Consequently, when confectionery rope 30 leaves cooling chamber 34 on conveyor 32, stabilized gel component 26 has thoroughly gelled.

Conveyor 32 subsequently passes confectionery rope 30 through metal detector 35 and on to cutting device 36. Cutting device 36 cuts confectionery rope 30 into individual pieces 38 of confectionery product 40. Confectionery rope 30 is advantageously cut into individual pieces without any sticking or adherence of the pieces to the cutting machinery. This non-stick cutting is advantageously ensured by thoroughly cooling the confectionery rope, and the gel component in particular, in the cooling chamber. Pieces 38 are subsequently delivered by way of conveyor 32 to a wrapping device 41, where each piece 38 is individually wrapped in a wrapper or packaging. A further advantage of the present system is that the complete gelling of the stabilized gel component by way of the cooling chamber further ensures that the confectionery product, and the gel component in particular, does not stick or otherwise adhere to the packaging. In an embodiment, wrapping device 41 wraps about 1300 pieces of confectionery product 40 per minute.

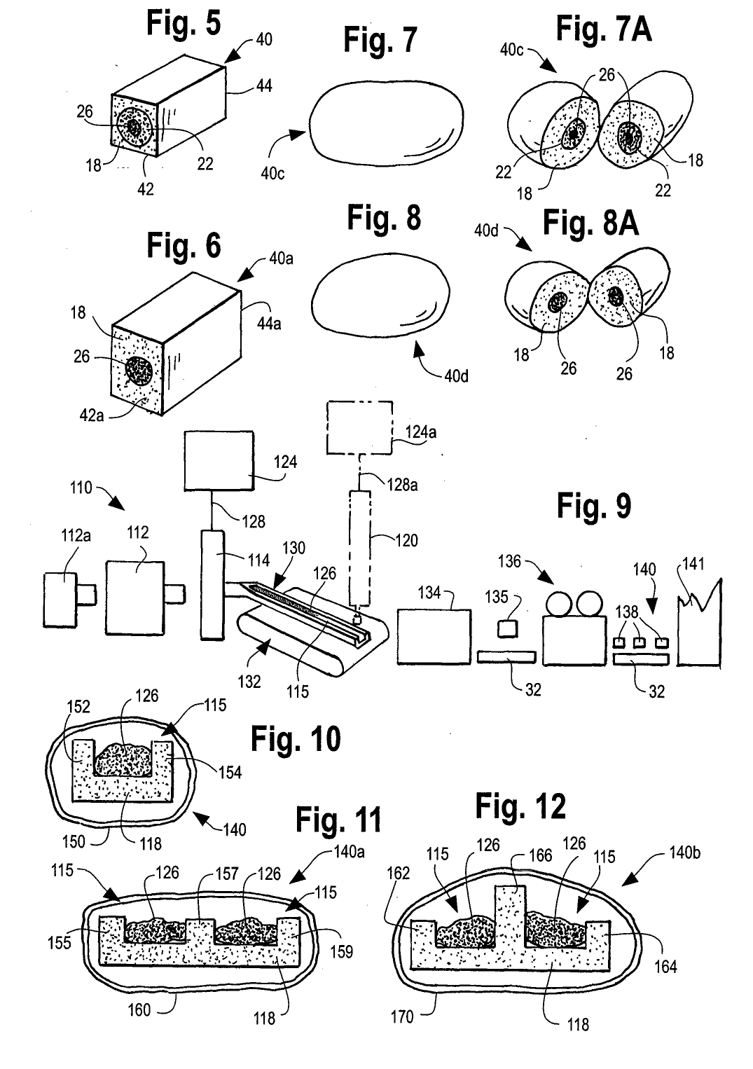

FIGS. 5 and 6 illustrate individual pieces of confectionery product 40 and 40a. Product 40 and 40a include ends 42, 44 and 42a, 44a respectively. Product 40 includes chewing gum substrate 18, trim gum layer 22, and stabilized gel component 26 that are visible from end 42 (and, in an embodiment, visible from end 44). Product 40a includes chewing gum substrate 18, and stabilized gel component 26 as visible from end 42a (and, in an embodiment, visible from end 44a). As can be seen in FIGS. 5 and 6, chewing gum substrate 18 (and trim gum 22 in FIG. 5) surround stabilized gel component 26. Exposure of gel component 26 (and trim gum 20 in FIG. 5) may be the result of the cutting procedure performed by system 10. In an embodiment, the chewing gum substrate may have a substantially square cross-section shape as shown in FIGS. 5 and 6.

In an embodiment, confectionery products 40c and 40d may be formed so that stabilized gel component 26 may be encased or wholly surrounded by chewing gum substrate 18 and trim gum 22 (FIGS. 7, 7a). Alternatively, product 40d may enclose stabilized gel component with chewing gum substrate 18 as shown in FIGS. 8, 8a. In an embodiment, the chewing gum substrate may have a substantially circular or O-shaped cross section as shown in FIGS. 7a and 8a. This may be accomplished by sealing the ends of the confectionery product during formation of the individual pieces from the confectionery rope or other procedure as is commonly known in the art.

FIG. 9 illustrates a further embodiment, whereby system 110 may include extruder 112, pre-extruder 112a and nozzle 114 which may be configured to extrude chewing gum substrate 118 as a confectionery rope 130 with one or more channels 115 onto conveyor 132. Nozzle 114 may be placed in fluid communication with a source 124 of stabilized gel component 126 by way of tubing 128. Source 124 may or may not be portable gel injection system 200 as previously described. Nozzle 114 may be further adapted or configured to dispense stabilized gel component 126 simultaneously or substantially simultaneously with the extrusion of chewing gum substrate 118.

In an embodiment, dispensing device 120 may be placed downstream of nozzle 114. Dispensing device 120 may be in fluid communication with source 124a of stabilized gel component 126 to dispense an amount of the stabilized gel component into channel 115. Source 124a may or may not be portable gel injection system 200 as previously described.

Regardless whether the stabilized gel component is dispensed with nozzle 114 or by way of dispensing device 120, rope 130 may continue through cooling chamber 134, metal detector 135, and cutting device 136 where it is cut into individual pieces 138 of confectionery product 140 as previously described. Individual pieces 138 of confectionery product 140 may be wrapped or packaged with wrapping device 141 as previously described.

In FIG. 10, a cross sectional view of confectionery product 130 disposed in packaging 150 is shown in accordance with an embodiment of the present disclosure. The U-shape cross section of confectionery product 140, and chewing gum substrate 118 in particular, defines channel 115. In an embodiment, stabilized gel component 126 may be dispensed in channel 115 such that the amount of the stabilized gel component does not exceed the height of vertical members 152 and 154. This arrangement advantageously prevents stabilized gel component from contacting packaging 150. This arrangement also protects the stabilized gel component from handling during shipping and/or storing. Vertical members 152 and 154 further reduce the chance of contact between processing equipment and stabilized gel component 126.

In a further embodiment, the confectionery product may have more than one channel. FIG. 11 shows a cross sectional view of confectionery product 140a in wrapping 160, confectionery product 140a having a W-shaped, or a sideways E-shaped cross sectional shape in accordance with a further embodiment of the present disclosure. The W-shaped cross-section provides product 130a with two channels 115 into which stabilized gel component 126 may be dispensed. In an embodiment, the amount of stabilized gel component dispensed in each channel is lower than the height of vertical members 155, 157, and 159. Vertical members 155, 157, and 159 may protect stabilized gel component 126 as previously discussed.

In a further embodiment, cross sectional W-shaped or sideways E-shaped confectionery product 140b may include middle vertical member 166 that may be taller than outer vertical members 162 and 164 as shown in the cross-sectional view of confectionery product 140b in wrapping 170 of FIG. 12. Increasing the height of middle vertical member 166 provides further protection to stabilized gel component 126 during shipping, handling and storing. Moreover, heightened middle vertical member 166 provides further assurance that stabilized gel component 126 will not stick or adhere to wrapping 170.

By way of example and not limitation, examples of the present invention will now be given.

TABLE 3
Orange-Stabilized Gel Component (Sugar-Free)

| | | | | % Dry |
|---|---|---|---|---|
| INGREDIENT | Weight (g) | % IN | % OUT | Solids |
| LOCUST BEAN GUM | 0.880 | 0.10% | 0.13% | 90.00% |
| Carageenan K + | 4.620 | 0.53% | 0.67% | 90.00% |
| Carrageenan IOTA | | | | |
| WATER | 50.000 | 5.76% | 7.20% | 0.00% |
| MALITOL SYRUP | 800.000 | 92.09% | 115.15% | 72.00% |
| Banana Flavor | 1.100 | 0.13% | 0.16% | 99.00% |
| Yellow colors | 3.000 | 0.35% | 0.43% | 70.00% |
| Citric acid | 9.100 | 1.05% | 1.31% | 70.00% |
| TOTAL IN | 868.70 | 100% | 125.04% | 67.98% |
| WATER LOST | −173.98 | | −25.04% | |
| TOTAL OUT | 694.72 | | 100.00% | 85.00% |

TABLE 4
Strawberry-Milk Shake - Stabilized Gel Component (Sugar-Free)

| | | | | % Dry |
|---|---|---|---|---|
| INGREDIENT | Weight (g) | % IN | % OUT | Solids |
| LOCUST BEAN GUM | 1.040 | 0.12% | 0.15% | 90.00% |
| Carageenan K + | 5.460 | 0.63% | 0.79% | 90.00% |
| Carrageenan IOTA | | | | |
| MILK POWDER | 4.900 | 0.56% | 0.71% | 98.00% |
| SALT | 2.100 | 0.24% | 0.30% | 99.00% |
| WATER | 50.000 | 5.76% | 7.20% | 0.00% |
| MALITOL SYRUP | 800.000 | 92.09% | 115.15% | 72.00% |
| STRAWBERRY FLAVOR | 1.100 | 0.13% | 0.16% | 99.00% |
| CREAM FLAVOR | 0.500 | 0.06% | 0.07% | 99.00% |
| Red dye color solution | 2.600 | 0.30% | 0.37% | 10.00% |
| Lactic acid | 5.000 | 0.58% | 0.72% | 70.00% |
| TOTAL IN | 872.70 | 100% | 125.62% | 68.39% |
| WATER LOST | −170.57 | | −24.29% | |
| TOTAL OUT | 702.13 | | 101.33% | 85.00% |

TABLE 5
Caramel-Stabilized Gel Component

| | | | | % Dry |
|---|---|---|---|---|
| INGREDIENT | Weight (g) | % IN | % OUT | Solids |
| LOCUST BEAN GUM | 0.845 | 0.08% | 0.10% | 90.00% |
| Carageenan K + | 4.290 | 0.39% | 0.50% | 90.00% |
| Carrageenan IOTA | | | | |
| CRYSTAL SUGAR | 371.800 | 34.18% | 43.47% | 99.90% |
| MILK POWDER | 4.940 | 0.45% | 0.58% | 98.00% |
| WATER | 283.920 | 26.10% | 33.20% | 0.00% |
| CORN SYRUP | 417.993 | 38.42% | 48.87% | 82.00% |
| Flavor | 2.6 | 0.24 | 0.30% | 99.00% |
| CARAMEL COLOR | 1.430 | 0.13% | 0.17% | 70.00% |
| TOTAL IN | 1087.82 | 100% | 127.19% | 66.83% |
| WATER LOST | −232.53 | | −27.19% | |
| TOTAL OUT | 855.29 | | 100.00% | 85.00% |

TABLE 6
Banana Milk Shake-Stabilized Gel Component

| | | | | % Dry |
|---|---|---|---|---|
| INGREDIENT | Weight (g) | % IN | % OUT | Solids |
| LOCUST BEAN GUM | 0.845 | 0.08% | 0.10% | 90.00% |
| Carageenan K + | 4.290 | 0.39% | 0.50% | 90.00% |
| Carrageenan IOTA | | | | |
| CRYSTAL SUGAR | 371.800 | 33.84% | 43.00% | 99.90% |
| MILK POWDER | 4.900 | 0.45% | 0.57% | 98.00% |
| SALT | 2.100 | 0.19% | 0.24% | 99.00% |
| WATER | 283.920 | 25.84% | 32.84% | 0.00% |
| CORN SYRUP | 417.993 | 38.05% | 48.34% | 82.00% |
| Banana Flavor | 1.100 | 0.10% | 0.13% | 99.00% |
| Yellow colors | 2.600 | 0.24% | 0.30% | 70.00% |
| Lactic acid | 9.100 | 0.83% | 1.05% | 70.00% |
| TOTAL IN | 1098.65 | 100% | 127.06% | 66.90% |
| WATER LOST | −233.98 | | −27.06% | |
| TOTAL OUT | 864.66 | | 100.00% | 85.00% |

TABLE 7
Banana Bubble Gum With Chocolate Crème Gel Filling

INGREDIENT
BUBBLE GUM BANANA FLAVOURED
FILLING CHOCOLATE FLAVOURED
BG BANANA FLAVOURED
MILLED SUGAR
GUM BASE
GLUCOSE SYRUP
CITRIC ACID
GLYCERINE
BANANA FLAV
TRIACETINE
COLOR
FILLING CHOCOLATE FLAVOURED
GLUCOSE SYRUP
MIXTURE DRY SOLIDS
MIX HYDROCOLLOIDS-SOLUTION
Chocolate Flav
MIX HYDROCOLLOIDS-SOLUTION
Water
Locust Bean Gum
Carregeenan
Crystal Sugar
MIXTURE DRY SOLIDS
Crystal sugar
Cocoa powder
Milk powder 26% (whole)
Salt
CONDENSED FORMULA-CHOCOLATE
FILLING PART
Locust Bean gum
Carregeenan
Crystal sugar
Cocoa powder
Whole Milk in Powder
Salt
Water
Glucose Syrup
Chocolate Flav

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A confectionery article comprising:
a confectionery substrate; and
a stabilized gel component in contact with the confectionery substrate.

2. The confectionery article of claim 1 wherein the confectionery substrate is selected from the group consisting of chewing gum, bubble gum, trim chewing gum, nougat, pliable confectionery material, taffy, soft candy, chewy candy, caramel, hard candy, and combinations thereof.

3. The confectionery article of claim 1 wherein the stabilized gel component further comprises a hydrocolloid, a stabilizing agent, a flavorant, a sweetener, a dairy component and combinations thereof.

4. The confectionery article of claim 3 wherein the hydrocolloid is selected from the group consisting of gelatin, gellan gum, xanthan gum, pectin, carrageenan, and combinations thereof.

5. The confectionery article of claim 3 wherein the stabilizing agent is selected from the group consisting of agar, alginate, locust bean gum, carrageenan, iota carrageenan, kappa carrageenan, and combinations thereof.

6. The confectionery article of claim 1 wherein the confectionery substrate is from about 50% to about 90% by weight of the confectionery article.

7. The confectionery article of claim 1 wherein the stabilized gel component is from about 10% to about 50% by weight of the confectionery article.

8. A multiple phase chewing gum composition comprising:
a chewing gum substrate; and
a stabilized gel component in contact with the chewing gum substrate.

9. The chewing gum composition of claim 8 wherein the chewing gum substrate is selected from the group consisting of chewing gum, bubble gum, trim chewing gum, and combinations thereof.

10. The chewing gum composition of claim 8 wherein the stabilized gel component further comprises a component selected from the group consisting of a hydrocolloid, a stabilizing agent, a flavorant, a sweetener, a dairy component, and combinations thereof.

11. The chewing gum composition of claim 10 wherein the hydrocolloid is selected from the group consisting of xanthan gum, pectin, carrageenan, and combinations thereof.

12. The chewing gum composition of claim 10 wherein the stabilizing agent is selected from the group consisting of alginate, locust bean gum, carrageenan, iota carrageenan, kappa carrageenan, and combinations thereof.

13. The chewing gum composition of claim 8 wherein the stabilized gel component has a property selected from the group consisting of a cream texture, a creamy mouthfeel, a cream flavor, and combinations thereof.

14. The chewing gum composition of claim 8 wherein the stabilized gel component has a set point temperature from about 90° C. to about 92° C.

15. The chewing gum composition of claim 8 wherein the stabilized gel component has a Brix value from about 85 to about 87.

16. The chewing gum composition of claim 8 wherein the chewing gum composition has a channel extending along a length thereof, and an amount of the stabilized gel component is disposed in the channel.

17. The chewing gum composition of claim 8 wherein the chewing gum substrate has a cross-section shape selected from the group consisting of square-shaped, E-shaped, O-shaped, U-shaped, and W-shaped.

18. The chewing gum composition of claim 8 wherein the chewing gum substrate encases the stabilized gel component.

19. The chewing gum composition of claim 8 wherein the chewing gum composition further comprises an end, the stabilized gel component visible at the end.

20. The chewing gum composition of claim 8 wherein the chewing gum substrate is a trim chewing gum, the chewing gum composition further comprising a second chewing gum substrate encasing the trim chewing gum and the stabilized gel component.

21. The chewing gum composition of claim 8 further comprising a package containing the chewing gum composition therein, the stabilized gel component in non-adherence with the package.

22. A method of producing a multiple phase confectionery article comprising:
extruding a confectionery substrate;
dispensing a stabilized gel component upon the confectionery substrate to form a confectionery composite, the stabilized gel component having a gel set point temperature, the temperature of the stabilized gel component above the set point temperature; and
lowering the temperature of the confectionery composite below the gel set point temperature to gel the stabilized gel component and form the confectionery article.

23. The method of claim 22 further comprising maintaining the stabilized gel component in a fluid state during the dispensing.

24. The method of claim 22 further comprising maintaining the temperature of the fluid stabilized gel component above the set point temperature during the dispensing.

25. The method of claim 22 wherein the lowering further comprises passing the article through a cooling chamber having a temperature from about −2° C. to about 2° C. for about 1 minute to about 7 minutes.

26. The method of claim 22 further comprising coextruding the stabilized gel component with the confectionery substrate.

27. The method of claim 22 further comprising forming a channel in the confectionery substrate and dispensing the stabilized gel component in the channel.

28. The method of claim 22 further comprising placing the confectionery article in a package, the stabilized gel component not adhering to the package.

29. The method of claim 28 wherein the placing occurs within about 1 minute to about 10 minutes after the lowering.
